(19) United States
(12) Patent Application Publication
(10) Pub. No.: US 2015/0271235 A1
(43) Pub. Date: Sep. 24, 2015

(54) System And Method For Predicting Buffering And Network Shaping

(71) Applicant: Giraffic Technologies Ltd., Tel Aviv (IL)

(72) Inventors: Yoel Zanger, Tel Aviv (IL); Gil Gat, Tel Aviv (IL); Rotem Epelbaum, Ramat Gan (IL); Offer Atzitz, Tel Aviv (IL)

(73) Assignee: Giraffic Technologies Ltd., Tel Aviv (IL)

(21) Appl. No.: 14/287,276

(22) Filed: May 27, 2014

(30) Foreign Application Priority Data
Mar. 24, 2014 (IL) 231685

(51) Int. Cl. H04L 29/06; H04L 12/925

(52) U.S. Cl. CPC H04L 65/602; H04L 47/722

(57) ABSTRACT

Adaptive video streaming system and method comprising a computer network comprising a data source; a video player; a session controller configured to use in parallel a variable number of streams in order to maximize download throughput from said data source to said video player; and an adaptive streaming optimizer connected between said data source and said video player, the adaptive streaming optimizer configured to predict the next resolution to be requested by the player and determine which fragments to download accordingly.

### TECHNICAL FIELD

The present invention relates to the field of computer networks, and more particularly, to improving adaptive video streaming display in such networks.

### BACKGROUND

A common problem encountered by many internet users is low adaptive video streaming watching experience.

Two main problems that harm the end user watching experience are viewing of medium video resolution and frequent resolution changes.

The players try to solve these issues by gathering a buffer of data and measuring the downloading data rate in order to decide about resolution change. Changing network/communication link conditions may cause network bursts. This behavior can cause rapid resolution changes. These changes degrade the overall user experience and should be avoided.

There is need for a method that will guarantee maximal bit-rate play of adaptive streaming while minimizing player resolution changes, for better watching experience.

### SUMMARY

According to a first aspect of the present invention there is provided an adaptive video streaming system comprising: a computer network comprising a data source; a video player; a session controller configured to use in parallel a variable number of streams in order to maximize download throughput from said data source to said video player; and an adaptive streaming optimizer connected between said data source and said video player, the adaptive streaming optimizer configured to predict the next resolution to be request by the player and determine which fragments to download accordingly. According to another aspect of the present invention there is provided a method of adaptive video streaming optimization comprising: receiving from a video player a request for an adaptive video stream to be downloaded from a given URL in a specified resolution; downloading fragments of the specified resolution from the given URL and uploading them to the player at the same rate; and after a pre-determined time has elapsed—attempting to increase the current resolution of fragments uploaded to the player.

Attempting to increase the resolution may comprise maximizing the download rate of current resolution fragments from the given URL and limiting the upload rate of the current resolution fragments to the player below a next higher resolution.

The method may further comprise downloading fragments of the next resolution into a second buffer and uploading fragments to the player from the second buffer if the player requests the next resolution and the second buffer is full enough.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic block diagram of a prior-art adaptive video streaming system;

FIG. 2 is a schematic block diagram of an adaptive video streaming system according to the present invention;

FIG. 3 is a general flowchart showing the processing performed by the adaptive streaming optimizer according to the present invention;

FIG. 4 is a detailed flowchart showing the optimization process performed by the adaptive streaming optimizer according to the present invention; and

FIG. 5 is a graph showing empirical results of using the optimization according to the present invention.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention attempts to overcome the shortcoming of prior art adaptive video streaming systems by guaranteeing maximal bit-rate play of adaptive streaming while minimizing player resolution changes.

This goal is achieved by:
1. Shaping the network bursts and predicting the next resolution, thus guaranteeing high quality video with minimal resolution changes.
2. Maximizing download speed for a given internet connection, thus guaranteeing that the player displays the highest resolution possible at minimal resolution changes.

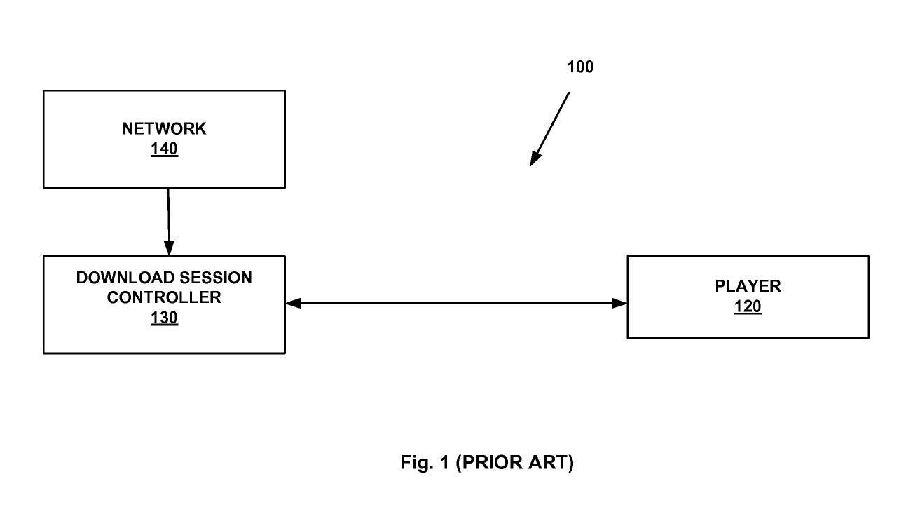

FIG. 1 is a schematic block diagram of a prior-art adaptive video streaming system 100, as described in co-pending International Patent Application No. PCT/IB2013/059334, comprising a computer network (data source) 140, a video player 120 and an intermediate session controller 130. The session controller 130 provides a general mechanism independent of the content being downloaded or its play rate that uses in parallel a variable number of streams in order to maximize the link throughput at any time.

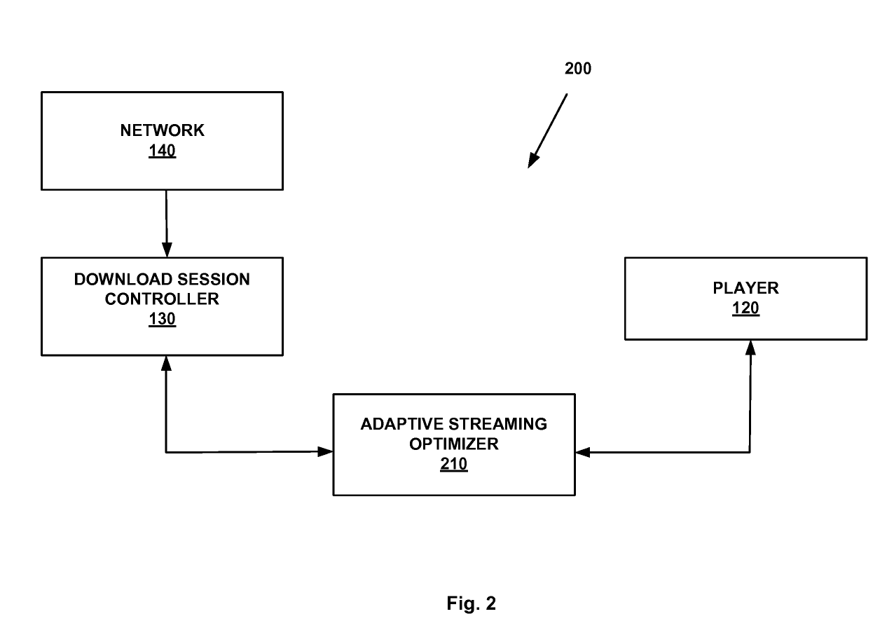

FIG. 2 is a schematic block diagram of an adaptive video streaming system 200 according to the present invention, additionally comprising an adaptive streaming optimizer 210, for predicting the next resolution to be request by the player and determining the downloaded fragments accordingly.

In adaptive streaming, each stream of a given quality (resolution) is built from fragments, so the player can switch to a different stream quality between fragments.

In order to accelerate Adaptive Presentations—we need to download fragments BEFORE the player requests them.

In order to do that—we need to know which streams are available in the presentation, their relations, and the fragments of each individual streams.

This information is found in the Manifest file of the presentation.

“.m3u8” for HLS
“/manifest” for SmoothStreaming
“.mpd” for MPEG-DASH

The player also needs to know this metadata—so it asks for it in order to play. According to the present invention, the manifest request is intercepted by the optimizer 210, e.g. by specific integration or by proxy auto-config (PAC), the response is parsed, the URL of the stream source is replaced with the URL of the optimization module 210, and the modified version of the manifest is returned to the player 120.

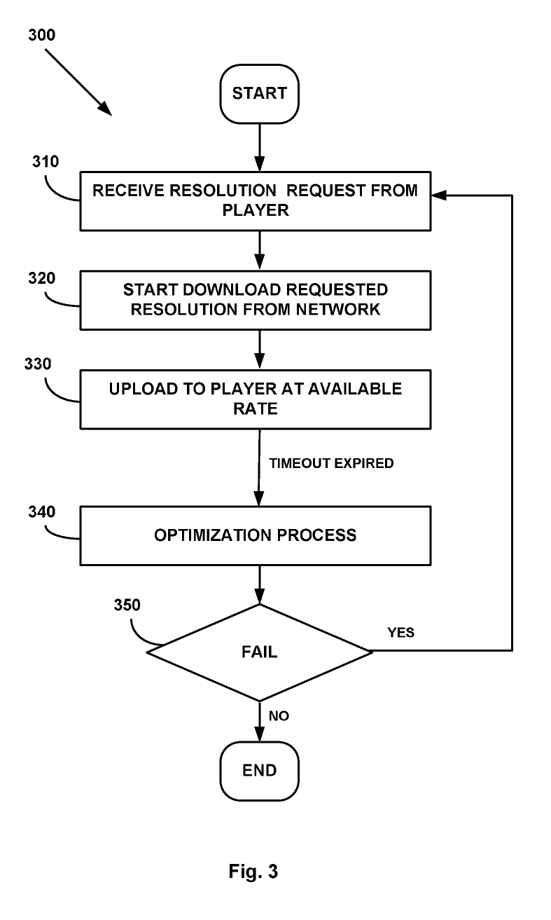

FIG. 3 is a general flowchart 300 showing the processing performed by the adaptive streaming optimizer 210 according to the present invention.

In step 310 the optimizer receives from the player a request for an adaptive video stream to be downloaded from a given URL. The player specifies the required resolution.

In steps 320 and 330 the optimizer starts downloading fragments of the requested resolution from the given URL and uploading them to the player at the same rate.

At this stage no optimization is done yet, to allow the optimizer enough time for its startup procedure.

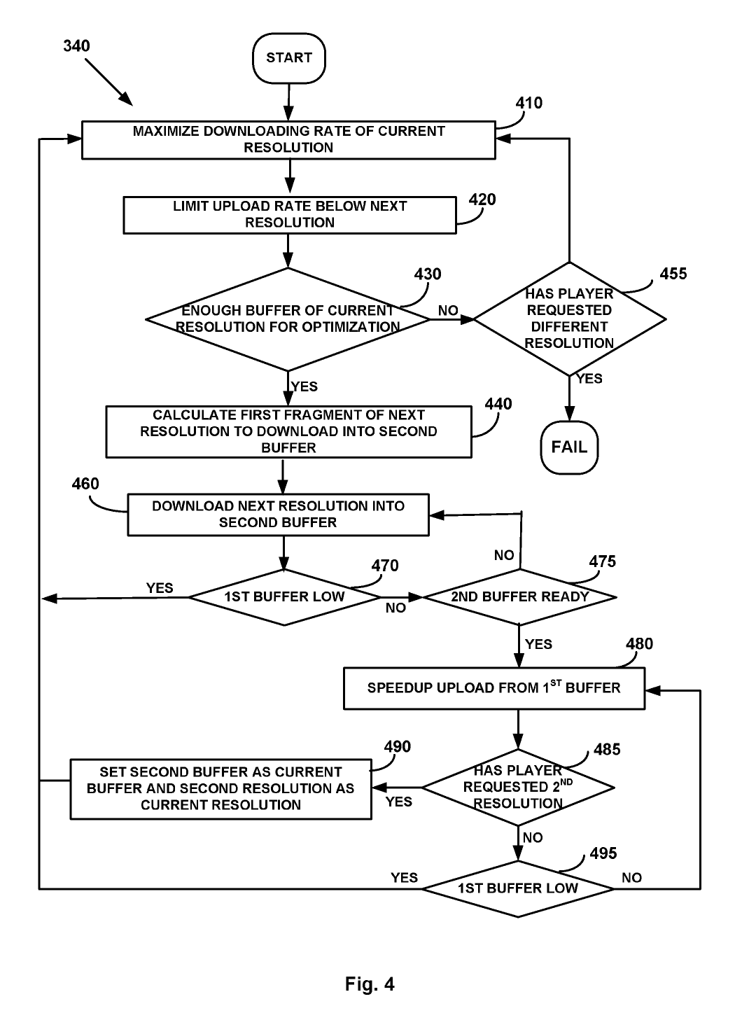

In step 340, once the startup time has expired, the optimizer begins performing the optimization process, as will be detailed below in conjunction with FIG. 4.

The optimization process may end:
a. By returning a “Fail” status, in which case the optimizer goes back to step 310 where the player controls the download resolution and rate;
b. By reaching the end of the video stream.

FIG. 4 is a detailed flowchart showing the optimization process 340 performed by the adaptive streaming optimizer 210 according to the present invention.

In step 410 the process continues the download of the current resolution fragments at the maximal rate and at the same time limits the upload rate to be just below the rate required for the next (higher) resolution (step 420). This is intended to causes the player to request the next (higher) resolution.

In step 430 the process checks whether the current resolution buffer is full, or has at least enough data to provide to the player till the next resolution buffer is ready for uploading.

The calculation involves:
a. Time required for downloading the next resolution buffer;
b. Time the player requires to transfer to the next resolution once it receives higher rate of data;
c. Time required for reverting to the current resolution if the next buffer is not filled in the expected time.

If the calculation indicates no possibility for resolution enhancement, the the last resolution requested by the player is tested to find out if it is different than both first and second resolutions. This could be caused, for example, by network problems. In this case the process returns a “Fail” status. Otherwise, the process returns to step 410.

In step 440 the process calculates which fragment of the next resolution should be downloaded. The calculation takes into consideration how long it will take to have enough data in the new resolution buffer to start uploading from it.

In step 460 the process starts downloading fragments into the second resolution buffer according to the previous calculation.

In step 470 the process checks whether the first buffer, from which upload to the player is currently being done, is too low to sustain the player in the current resolution. If it is, the process returns to step 410 to continue downloading the current resolution. Otherwise, if the first buffer is full enough, the process checks (step 475) whether the second buffer is ready, i.e. is full enough to start uploading the second resolution to the player. If not—downloading into the second buffer continues in step 460.

If the second resolution buffer is found to be full enough—upload from the current (first) buffer to the player is speeded up (step 480), in order to cause the player to request the second (higher) resolution.

In step 485 the process checks whether, as expected, the player has requested the second resolution. If it has—the buffers are switched, namely the second resolution buffer is set as the current buffer and the second resolution is set as the current resolution (step 490), thus increasing the quality of data sent to the player.

The process then returns to step 410 to try and further improve the data quality.

Otherwise, if no request for the second resolution has been received from the player after having speeded up the upload, the process checks again whether the first buffer, from which upload to the player is currently being done, is too low to sustain the player in the current resolution (step 495). If it is, the process returns to step 410 to continue downloading the current resolution. Otherwise, the upload speedup process continues in step 480.

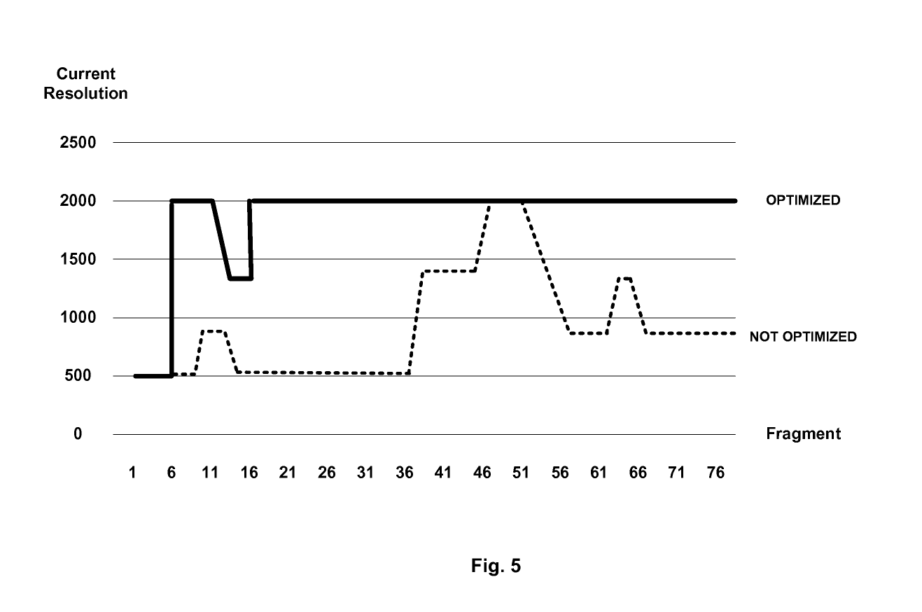

FIG. 5 is a graph showing empirical results of using the optimization according to the present invention, showing a stable high resolution as compared to the prior art non-optimized method.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

1. An adaptive video streaming system comprising:
a computer network comprising a data source;
a video player;
a session controller configured to use in parallel a variable number of streams in order to maximize download throughput from said data source to said video player; and
an adaptive streaming optimizer connected between said data source and said video player, the adaptive streaming optimizer configured to predict the next resolution to be requested by the player and determine which fragments to download accordingly.

2. A method of adaptive video streaming optimization comprising:
receiving from a video player a request for an adaptive video stream to be downloaded from a given URL in a specified resolution;
downloading fragments of the specified resolution from the given URL and uploading them to the player at the same rate; and
after a pre-determined time has elapsed—attempting to increase the current resolution of fragments uploaded to the player.

3. The method of claim 2, wherein said attempting to increase the resolution comprises maximizing the download rate of current resolution fragments from the given URL and limiting the upload rate of the current resolution fragments to the player below a next higher resolution.

4. The method of claim 3, further comprising downloading fragments of the next resolution into a second buffer and uploading fragments to the player from the second buffer if the player requests the next resolution and the second buffer is full enough.
